(19) United States
(12) Patent Application Publication
(10) Pub. No.: US 2015/0069118 A1
(43) Pub. Date: Mar. 12, 2015

(54) ANIMAL TRACKING

(71) Applicant: Curtis Roys, Kingsland, TX (US)

(72) Inventor: Curtis Roys, Kingsland, TX (US)

(21) Appl. No.: 14/321,389

(22) Filed: Jul. 1, 2014

Related U.S. Application Data
(60) Provisional application No. 61/841,734, filed on Jul. 1, 2013.

(51) Int. Cl. G06F 17/30; G09F 3/00

(52) U.S. Cl. CPC G06F 17/30879; G09F 3/0297; G06F 17/30241
USPC 235/380

(57) ABSTRACT

A method and apparatus for reporting dead wildlife, such as animals killed by hunters, in accidents, or dying from natural causes is disclosed. A machine-readable tag is issued to a hunter or other individual. The hunter or other individual is issued a unique identifier linked to that person. The information in the animal tag and the unique identifier of the person or class of persons that possesses the tag is then uploaded to a database. When an animal is killed, or a dead animal is found, the tag is attached to the dead animal and then scanned by a device having geographic information, such as from GPS. An image of the dead animal along with the location information is uploaded, such as through a cell phone communications system, a satellite communication system, or other communications system, into a database. The database can be queried by law enforcement personnel to confirm the legality of the kill, by game management officials to track wildlife, by a landowner to determine game harvested on his land, or others.

This application claims priority from U.S. Prov. Pat. App. No. 61/841,734, filed Jul. 1, 2013, which is hereby incorporated by reference.

### TECHNICAL FIELD OF THE INVENTION

The invention relates to documenting and the management of harvested wildlife.

### BACKGROUND OF THE INVENTION

Parks and Wildlife management across the United States have several methods for reporting the quantity and type of wildlife that are harvested by hunters and landowners. Several methods are in place to report harvested wildlife in the United States, but all methods are extremely expensive, labor intensive, and none have ever been extremely successful or accepted by the hunting population. Most if not all of these tracking methods require manual registration on the part of the hunter or landowner, by phone or computer to register harvested wildlife. Then these records that are filled in by hunters must be manually entered into each state's database.

The term “deer” hereinafter is used as an example for harvesting or killing wildlife across the United States. It should be recognized that using the term “deer” is only an example and not specific to deer but all types of wildlife. State, government, and local agencies worldwide are dedicating hundreds of man-hours and millions of dollars trying to accurately document the type and quantity of harvested or accidentally killed wildlife.

Wildlife harvest reports are useful because state and government agencies and deer hunters utilize them to identify the densest deer populations. Then they can quantify the numbers for planning the next year's hunting permits or, in the case of hunters, their next year's hunting excursions. Some states use the harvest reports in an effort to break down harvesting by each county, game type, place the animal was killed and hunter type. This enables or identifies trends of harvesting and deer population over a period of time.

Some county and state deer harvest reports are funded in part by the purchase of hunting licenses and tags. Funding that has come from the government has been either cut drastically or eliminated altogether. This lack of funds has resulted in some states not updating their deer harvest statistics for several years.

Most states try to collect harvested wildlife using information from ear tags that are required to be attached to animals immediately after each animal is killed and before the animal is removed from the location of the killing. The identification must be an approved tag supplied by the state and must be attached to the animal. The approved tag records, in ink, the date of harvest on the tag. Other states require harvest report cards that are manually filled out by hunters. By law these report cards must be turned in to the state. Several years ago in one state, it was reported only 40% of hunters who harvested a deer turned in their report card. The loss of information due to unreported harvesting requires the state office to estimate the deer harvest, making it difficult, if not impossible, for hunters to plan their hunts and much harder for the state to estimate the quantity of deer that can be allowed to be harvested or the number of permits that could be given out.

Tagging laws also vary from state to state, but, in most cases, an animal must be properly tagged immediately after the kill and before being moved from the spot of the kill. In some states, tags must be marked with the date of the kill as well as other information. All tags must be signed. In some states, metal self-locking tags are required, but whatever tags are used must be securely tied to the animal.

Many hunters follow through with whatever is required to report the wildlife harvested and believe it is their responsibility to report taking of wildlife. Of course if at any time the hunter does not abide by the states laws, major fines are imposed. The problem worldwide is to find a reliable and simple method to report and document the wildlife harvested. With the current method of collecting harvested wildlife, hunters must stop by a reporting station to register their kill, have a computer available with an internet connection to report their harvest online, or as in some states, call a hot-line called Telecheck to report the wildlife harvested.

The Telecheck system requires the hunter to call an 800 number, figure out which number to enter to get to the correct extension to report his or her kill, and then enter in his or her required information by keypad on the phone into an automated system. After this process is completed, the system gives the hunter a check number, which is needed to enter into a log to be processed. The process creates a harvest report containing the information the hunter entered in by telephone and has to be reviewed manually by state employees. This method is extremely labor intensive and time consuming. Unfortunately it is the only method available to access the impact of the previous year's harvest. This method enables those states with the Telecheck system to determine possible changes to the following year's license allocation, bag limits, season lengths, and possible policy changes.

Some states require that certain kinds of animals be presented to a game department official for inspection and tagging within a specified time after the kill. For example, within 72 hours of killing a bear in Wyoming, the hunter must “present the pelt and skull to a district game warden, district wildlife biologist, or department personnel at a Game and Fish Department Regional Office during business hours to register the killed animal. The pelt and skull must be presented in an unfrozen condition.

In Utah, mountain lion hunters have 48 hours to bring the lion to a conservation officer or division office. For permanent tagging, the information that must be presented by the hunter includes the date of harvest, the sex and age of the animal, body size measurements, any areas hunted, the weapon type used, and the hunter's hunting methods. Sometimes a hunter must possess a conservation or habitat permit in addition to a tag. Failure to comply with the specifics of the state where the animal is taken could result in a confiscated animal, a fine or both.

In some states such as Massachusetts, New Jersey, and New Hampshire, the use of mandatory deer check stations is required to manually report harvested deer. Unfortunately for the hunter, failure to comply with deer check stations can result in healthy fines.

Compiling deer harvest records for Massachusetts and several other states that require recording and reporting deer harvesting is strictly by a manual process. This process begins in October, when check stations are supplied with report forms, metal tags and envelopes for submitting carbon copies of hunter-reported deer. This system does not allow for updates being received throughout the year but is the only method in place that allows states to compare each year's data.

There is no consistency in reporting wildlife that was harvested. Some Massachusetts check stations submit reports on a weekly basis as requested; a few wait until the end of the season to return all the collected information at one time. Sometimes, Department of Natural Resources (DNR) personnel must visit individual check stations to retrieve harvest records that have not been turned in. The DNR must make every attempt to collect harvest records from each check station in order to try and analyze data before announcing a total deer harvest figure.

As check station reports are received at the DNR field offices, their staff must begin to enter the data manually. The volume increases dramatically once the firearms season begins. Additional staff from other locations must be called upon to assist in entering everything from tag numbers assigned to reported deer to the sex of the deer, equipment used by the hunter, and the county where the deer was taken.

The information is manually merged into one data base in early to mid-February. The pink carbon copies from the manual reports are sorted by county employees and stored in Bloomington for three years. The data base then must be checked for accurate spelling and to ensure there are no duplicate tag entries. This method costs the states millions of dollars in man hours.

For example, the requirements to report a kill by phone to register a Big Game Kill in North Carolina for bear, deer, and wild turkey, the following must be performed. Before moving the animal from the site of kill (where the animal fell), the hunter must validate his or her Big Game Harvest Report Card by punching or cutting in the appropriate cross-hair symbol that correctly identifies the big game animal harvested. The animal must then be registered by reporting the harvest within 24 hours and by recording the authorization number on his or her Big Game Harvest Report Card or Bonus Antlerless Report Card. Reporting must be done within 24 hours of kill and before the animal is skinned, dressed, or dismembered for consumption. If the animal is left unattended, for example in a cooler, before registering, it must be identified with the hunter's name, hunting license number and date of kill. If the animal is left with a processor or taxidermist, donated to Hunters for the Hungry or given to someone else, the authorization number from the state must be attached to the carcass.

The Big Game Harvest Report Card now includes a 9 digit Harvest ID number below each authorization line next to the name of each animal type. Hunters must locate the Harvest ID number next to the animal type they harvested and provide this number when registering the harvest through a cooperator agent, the telephone reporting system or the online reporting system. Hunters who obtain their license and big game privilege by phone will be given their Harvest ID numbers during the call. If the hunter harvests a big game animal before receiving the Big Game Harvest Report Card in the mail, the hunter must immediately, upon receipt of the Big Game Harvest Report Card, record the authorization number for the reported harvest on the line above the Harvest ID number he or she used when reporting the harvest.

In Delaware, the administrative code for natural resources and environmental control includes the following. With regards to attaching tags, each licensed person who hunts and kills a deer shall, immediately after the killing and before removing the deer from the location of the killing, attach an approved tag to the deer and record in ink the date of harvest on the tag. An approved tag shall mean an Antlerless Deer Tag or Doe Tag received with the hunting license, a Delaware Resident Quality Buck Deer Tag, a Delaware Resident Hunter's Choice Deer Tag, a Delaware Non Resident Quality Buck Deer Tag, a Delaware Non Resident Antlered Deer Tag, an Antlerless Deer Damage Tag, or an Antlerless Tag purchased in addition to the hunting license tags. Any unlicensed person not required to secure a license shall make and attach a tag to the deer that contains the person's name, address and reason for not having a valid Delaware hunting license.

With regards to the retention of tags, the tag required when attaching tags to a killed deer shall remain attached to the deer until the deer is processed for consumption.

When registering deer, each person who hunts and kills a deer shall, within 24 hours of killing said deer, register their deer by phone or over the internet through systems authorized by the Division. After registering a deer, hunters will be given a deer registration number. This number must be recorded in ink on the approved tags attached to the deer. It shall be unlawful to knowingly enter incorrect information when registering a deer.

In Ohio, every person who kills a deer must immediately fill out the temporary tag with the date and time the deer was killed. Attach the completed temporary tag to the deer at the place where it fell.
A hunter uses a holder to protect the tag from the elements. The hunter attachs a piece of string, wire, etc. to the temporary tag and protective holder before the hunt, and needs to carry a pen or pencil and a watch to fill out the temporary tag. The temporary tag must remain on the deer until it is permanently tagged. Once a temporary tag is detached from the permit, it is illegal to hunt or pursue deer with a hunting device without purchasing an additional valid deer permit.
For multiple deer permit holders, the first deer taken in the day must have been temporarily tagged before hunting or pursuing another deer.
Hunters with deer permits must use the temporary tag from the permit. Landowners and tenants who take a deer on their land and any other person not required to purchase a deer permit must make and attach their own tag with their name, address, and date and time killed. This tag must be attached to the dead deer immediately in the field at the place where it fell.
Instructions instruct the hunter to:
Protect the deer permit from the elements by placing them in a plastic bag or protective pouch before you hunt.
Every person who kills a deer must immediately fill out the temporary tag.
Attach the completed, protected temporary tag to the deer with string, twist-tie, or wire at the place where it fell.
Complete the automated game-check process. The 18-digit permanent tag number MUST be written on the permanent tag(s) in the spaces provided.
Detach the permanent tag and place it in a plastic bag or protective pouch.
   The completed permanent tag must be attached to the deer and then the temporary tag can be discarded.
   The Ohio automated game check and permanent tagging process no longer requires hunters to transport their deer to an official game-check station for permanent tagging. License agents will process game-check transactions, but will not visually inspect or permanently tag deer on behalf of hunters.
   The hunter must complete the automated game check and permanent tagging process by 12:00 p.m. (noon) the day after the kill or 11:30 p.m. the last day of the season.
   Hunters must have their permit with the attached permanent tag in hand to complete the game-check and permanent tagging process. Hunters can complete the automated game check and permanent tagging process in one of three ways: by telephone, on-line, or through an authorized license sales agent. Regardless of the game check method, the hunter must provide the 10-digit permit number, which is printed in large numbers on every permit.
   The hunter must answer a series of questions like those traditionally asked at game check stations. At the end of the process, the hunter will be issued an 18-digit permanent tag number. The first six digits are pre-printed on the permanent tag(s). When a hunter has game checked their deer by Web or agent, they will receive a game check receipt with their permanent tag number printed on it. Hunters using the telephone game check method will receive the final 12 digits of the number over the phone. The first six digits are pre-printed on the permanent tag(s).
   The 18-digit permanent tag number is be written on the permanent tag(s) in the spaces provided on the permanent tag(s). The first six digits are pre-printed on the permanent tag(s). The hunter must write the date and time of kill on the permanent tag and sign it.
   Deer hunter write the permanent tag number on both permanent tags. The completed permanent tag must then be attached to the deer. The temporary tag can be discarded. The game check and permanent tagging process is complete.
   For hunters, such as landowners and tenants, are not required to have deer permits, and must make and attach their own temporary tag. The temporary tag must include the name and address of the hunter and the date and time the animal was killed.
1. The landowner hunter must immediately attach the homemade temporary tag to the deer at the place where it fell. Once this step is completed, the hunter is free to transport it.
2. The hunter must complete the automated game check and permanent tagging process by 12:00 p.m. (noon) the day after the kill or 11:30 p.m. the last day of each season.
   The automated game check and permanent tagging process no longer requires hunters to transport their deer to an official game check station for permanent tagging. License agents will process game check transactions, but will not visually inspect or permanently tag deer on behalf of hunters.
   To game check a harvest online, make sure to use a computer connected to a printer. A game check receipt will be issued and must be printed. When using a smartphone for game check, you must access your customer account at wildohio.com when you are at a computer, click on the Game Check button, and print your game check receipt.
   At the time of the game check, the automated game check system will attempt to determine if the hunter has an existing customer ID using the hunter's last name, date of birth, and the last 4-digits of their SSN. If the system cannot find the hunter's account, a new one will be created.
   The resident landowner hunter must answer a series of questions like those traditionally asked at game check stations. When a landowner hunter has game checked their deer by Web or agent, they will receive a game check receipt with their permanent tag(s) and permanent tag number printed on it. The landowner hunter will be issued an 18-digit permanent tag number. The first six digits are pre-printed on the permanent tag(s).
   The 18-digit permanent tag number must be written on the permanent tag(s) in the spaces provided. The first six digits are pre-printed on the permanent tag(s). The hunter must write the date and time of kill on the permanent tag and sign it.
   Deer hunters must write the permanent tag number on both permanent tags. The completed permanent tag must then be attached to the deer. The temporary tag can then be discarded. The game check and permanent tagging process is complete.

In Wisconsin, starting with the Fall 2011 Wild Turkey season, hunters must register their turkey online or by phone. No in-person registration stations will be available. All deer killed must be registered in the unit of kill or in an adjoining unit. Deer killed in the Chronic Wasting Disease (CWD) Management Zone must be registered in the unit of kill or in an adjoining unit within the CWD Management Zone. All these requirements must be followed by the hunter on the Internet, online.

In Minnesota, there are three ways to register harvested deer. They include the following. (1) By Internet, the hunter goes to Minnesota's Online Licensing Center to register his or her deer. A confirmation number will be given, which must be recorded on the license in the appropriate area. (2) By telephone, the hunter uses the Interactive Voice Response (IVR). The system will accept either key punch or voice (e.g., press or say 1). He or she is asked to record a confirmation number so a pen must be in possession to complete the registration process. To register the hunter's deer using the IVR system, following the steps must be performed and are printed on the hunter's deer license. Step one is to dial 1-888-706-6367 to get into the system. Step two is to enter the Harvest Registration Number that appears on the license. It's a 9-digit number that links back to the person and license type. Step three involves entering the 3-digit area where the deer was killed. The system will only accept valid deer permit areas. Step four requires entering the date the deer was killed. Step five involves entering the type of deer—adult male, adult female, fawn male, fawn female. The final step of the system gives a confirmation number that must be written on the license in the appropriate area. (3) A hunter can register harvested deer at a walk in registration station. Registration stations display large, orange “Big Game Registration” signs. The person whose tag is on the deer must personally present the deer at an official registration station and receive a big game possession tag. The tag must be attached to the hind leg, ear, or antler where the site tag was attached.

The inconsistent records resulting from the various manual reporting systems used in different jurisdictions makes it impossible to accurately track the millions of wildlife harvested by hunters, killed by motor vehicles, or killed by other means. Landowners are unable to determine how many animals are harvested on their land. State and local agencies spend significant man-hours to track wildlife and still lose revenue by not accounting for harvested game.

### SUMMARY OF THE INVENTION

It is an object of the invention to provide a method and apparatus for a more reliable and simplified method of reporting harvested wildlife, which includes those killed by hunters and landowners, those accidentally killed by motorists, those dying of natural causes, and those dying by other means.

In accordance with a preferred embodiment, a tag, including machine-readable coded information preferably including a unique identifier for the tag and a second unique ID of a person or group to whom the tag is issued, is uploaded to a database and linked. When an animal is killed, or a dead animal is found, the tag is then attached to the dead animal. The tag is then scanned by a device having geographic information, such as from the global positioning system. An image of the dead animal along with the location information is uploaded, such as through a cell phone communications system, a satellite communication system, wireless internet, or other communications system, into a database. The unique ID of the reporting person is automatically included in the upload. The database can be optionally queried by law enforcement personnel to confirm the legality of the kill, by game management officials to track wildlife, by a landowner to determine game harvested on his land, or others.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a flowchart of the process according to one embodiment of the preferred invention.

FIG. 2 depicts a block diagram of devices according to an embodiment of the preferred invention connected through a network.

FIG. 3 depicts a flowchart of a method of tracking killed animals according to another embodiment of the preferred invention.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

It is recognized that all hunters must carry a hunting permit (license) to legally hunt wildlife not only in North America, but essentially worldwide. This preferred method will reliably document and report wildlife harvested by hunters.

In preferred embodiments, a regulatory system requires a tag or other electronically readable device to be attached to the harvested animal at the time of the kill. The tag includes a machine-readable code that can be linked with to the person holding the license.

In some embodiments, the machine readable code may be a bar code, a QRS code, or a radio frequency identification (RFID) code embedded in a microchip, such as an RFID microchip complying with ISO 11784 or 11785. This method of documenting harvested wildlife incorporates software that reads the barcode on the tag placed on the animal (by means of a smart phone, tablet, laptop computer, or other general purpose computing device programmed to implement the invention, or by means of an device manufactured specifically for reporting killed wildlife directly to government or state agencies). The smart phone (or specific device) takes a photo of the animal and documents the GPS location. The smart phone application also directs the hunter to check off or manually enter state specific information about the animal such as sex, estimated age, etc. Then the software transmits the information identifying the hunter, the vital statistics of the animal killed, a photograph of the animal and the location as indicated, for example, is GPS coordinates to a database accessible through a computer network via, for example, a private website, state agency or government website. This eliminates thousands of man hours and employees needed to enter information manually into a database. Fewer mistakes are made and the information is extremely accurate because all information is collected and uploaded automatically by a computerized handheld device immediately after the kill.

The information can be accessed by local government personnel, local authorities, game wardens or whoever is designated to legally view the information.

Local authorities, law enforcement officials and game wardens can employ a handheld scanner and at any given time they can scan the tag that has been attached to the deer or wildlife to ensure the killed animal has been reported as required by law. This scan can be done when the animal is on the landowner's property, being transported down the highway by automobile, in any public place, and even after the animal has been taken to a processing establishment. Regulations could require that the tag must follow the processed meat until the owner picks it up from the processing house. If at any time the tag is scanned and it has not been registered, a fine will be assessed on the person in possession of the animal. If there is no tag on the animal a fine will be issued immediately.

All land owners want and need to know when an animal has been killed and removed from their land to track the population of harvested animals. This new method of tracking harvested animals will give landowners immediate access to animals killed on their property. When the hunting permit is scanned to the state or government agency, the GPS location and photo is documented and a copy of the harvested animal is automatically emailed to the land owner for his records or the land owner can access his land to view the information. The land owner will have the option to require any hunter to show possession of the new scanning device or software on their smart phone before they will be allowed to hunt on the owner's property.

When an animal is found killed on the roadway, the normal procedure is to notify the county authorities, DPS (Department of Public Safety) or DOT (the Department of Transportation) then those agencies do their best to remove the carcasses out of traffic as quickly as possible. But these carcasses aren't always removed from the side of the road by the DOT. Sometimes the DOT contracts with a private company to clean up the carcasses. With the new device and concept the DPS, local, county & state authorities, and private entities contracted by the DOT will either be required to own or have access to the new scanning device. Now many animals that are killed by motorists or by other unknown means can be documented and accounted for by simply taking a photograph of the animal and pushing a button. The device will send the GPS location and photo of the animal to the state or government database automatically, so these animals can be documented and tracked.

After the tag is attached, the user uses an electronic device, such as a mobile phone running an app, to scan the tag, reading the information on the tag, and uploading the information to a database. The information that is uploaded is a combination of information read from the tag and information determined independently of the tag. Some of the information determined independently of the tag may be information derived from the device, such as a device identifier, class of user identifier, or individual identifier or positional information, such as GPS coordinates, determined by the device. Some of the information can be one or more photographs captured by the device or information manually entered by the user on a keyboard or touch screen. The uploaded information is associated in the database with information that was uploaded at the time the tag was issued, such as the person or group to whom the tag was issued. The information uploaded from the field is matched with information uploaded when the tag was issued using the unique identifier associated with the tag.

In some embodiments, the scanning software for smartphones or other computing devices can be downloaded free of charge from the state or governments website. In some implementations, those who don't possess a smart phone or other device can be required to pay a refundable deposit for a scanning device from the business or state agency where they obtain their hunting permit. If the permit is obtained on the internet on-line from the permitting agency, the hunter will be required to use a credit card or debit card to obtain a scanning device. Then the device will be shipped to them through the best method decided by the permitting agency, USPS, UPS, FedEx etc. The hunter will be required to pay for the non-refundable shipping and handling cost but the deposit for the device will be refunded when it is returned to the agency or any designated place of return by the state or government (gun shop, licensing agency, Wal-Mart etc.). With this new concept, software and devices will be extremely accurate and easy to use for hunters, agencies, etc. Simply stated, the process of the present invention is far better and simpler than previous methods for reporting harvested animals by hunters or killed animals by motorists.

This new method of reporting harvested animals will be more accurate and simple to use than any method used in the past. It will document the millions of animals and deer that die each year due to traffic accidents, disease, predators and starvation—which far exceed the numbers killed by hunters. This documentation will include quick and accurate reports, including precise location of deer and other animal populations that die due to an illness known as Chronic Wasting Disease (CWD) which is said to infect the animal population.

Hundreds of millions of dollars can be used for other needs of the state and government agencies due to the efficiency and effectiveness of this new technologically advanced device and software.

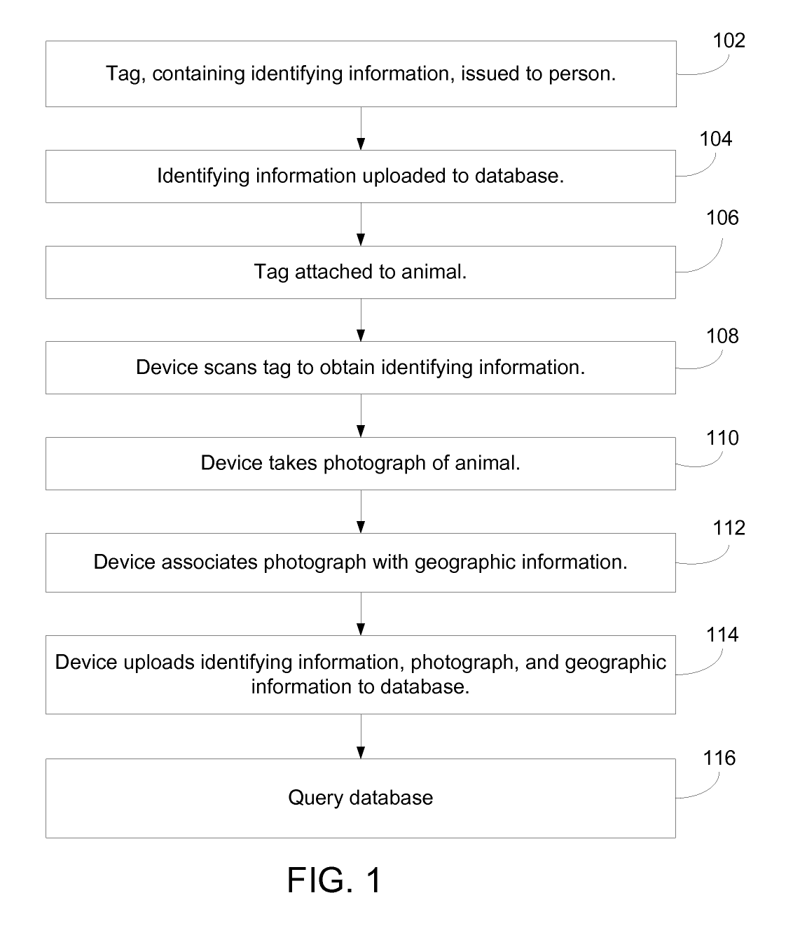

FIG. 1 shows one embodiment of the method of documenting harvested wildlife. In step 102, a tag, containing identifying information of the person that it is being issue to, is issued to the person who is either hunting or will come across a killed animal, such as in the case of the DOT, DPS, or wildlife management officials. The tag can be issued, for example, at a sporting goods store, a government agency, or any other location. The term tag includes any machine readable encoded information, such as a physical tag with a printed bar code or QRS code, as well as a code embedded in circuitry, such as an RFID pellet for embedding under the skin of the killed animal. In step 104, after the tag is issued, the identifying information is uploaded to one or more databases. When the animal is killed by the hunter or when a dead animal is discovered, in step 106, the tag is attached to the animal. In step 108, an electronic device, such as a smart phone, scans the tag to obtain the identifying information. In optional step 110, the device or smartphone also takes a photograph of the animal, and in step 112, the device associates the photograph with geographic information specific to the location of the killed animal. The hunter can also enter additional information about the animal, such as its sex, approximate age, and the manner in which the animal was killed, such as rifle or bow. In some embodiments, that include tracking animals killed outside of hunting, the cause of death, such as vehicle accident, starvation, or poisoning, may be recorded if known. In step 114, once the device or smartphone has obtained these pieces of information, the device uploads the identifying information, photograph, and geographic information to the database. The database or website used to store the information can also be accessed for inquiries regarding animals killed and their geographic locations. In step 116, the database is queried and supplies information to a requester. The database can also be accessed by someone other than the person to whom the tag was issued to confirm that the killing of the animal was uploaded to the database. A landowner can also access the database to acquire information regarding animals killed on his or her land. If the animal is killed by a collision with a vehicle, the information about the animal can be uploaded by a law enforcement officer or another government official. Other people accessing the database can include law enforcement officers, wildlife managers, game wardens, researchers and biologists.

The identifying information, photograph, and geographic information can be uploaded together or separately as well as at the same time or at different times. The information upload can be performed by any electronic means, which can include though a global computer network, though a satellite communication network, or through a telephone network.

The database can be a computer readable database containing information in electronic form which includes the images of the dead animals, geographical information describing the position of the dead animal, animal specific information such as sex and estimated age and identifying information of the person to whom the tag was issued. The database can also compile the information in the database of animals killed in a specific geographic region into a summary.

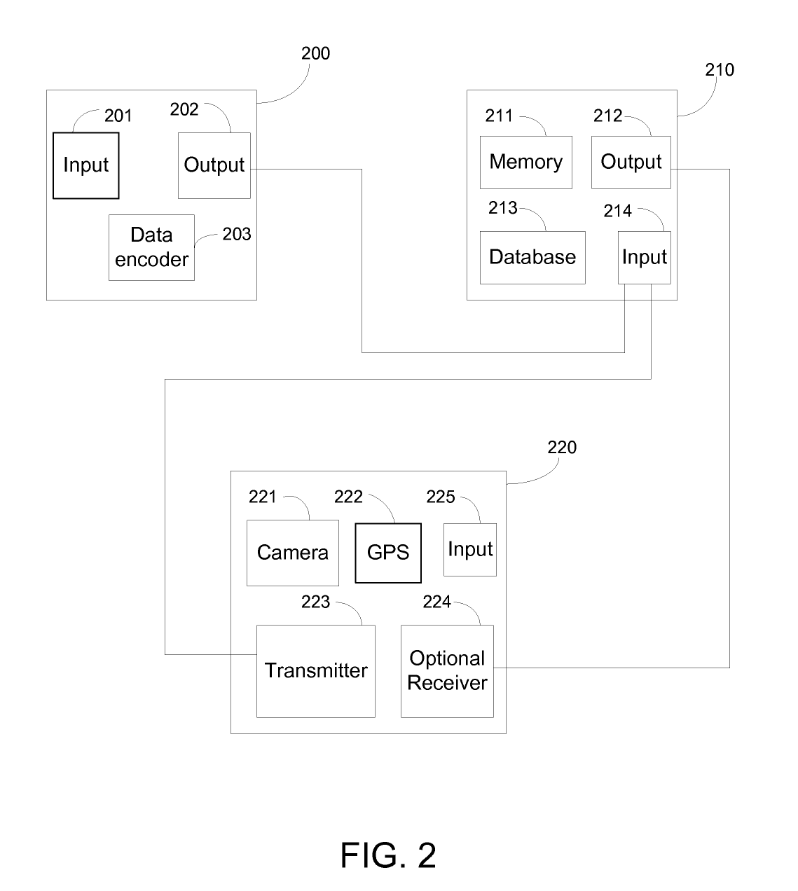

FIG. 2 depicts a several devices connected through a network according to one embodiment of the present invention. An issuing device 200, a computer 210, and a field use device 220 are connected over a network (not shown). The network is an example of one of the possible electronic means for transferring information from the devices 200, 220 to the computer 210 and vice versa. The issuing device 200 includes an input 201, an output 202 to link to the database computer 210, and a data encoder 203 for encoding identification data into, for example, a bar code, a QRS code, or an RFID. The computer 210 includes an input 214 and output 212 for linking to the issuing device 200 and field use device 220. The computer also has memory 211 for storing information uploaded from the issuing device 200 or the field use device 220 and a database 213 for accessing the information through a user interface, such as a website. The field use device 220 contains a camera 221 for taking photographs of the dead animal, a GPS 222 receiver for acquiring geographic coordinates to associate with the photographs, an input 225 for retrieving identifying information from, for example, bar codes, QRS codes, or RFIDs, a transmitter 223 for uploading the identifying information, photograph, and geographic coordinates to the computer 210, and an optional receiver 224 for confirming that the upload has been performed to the computer 210.

The field use device 220 can be a smartphone or some other electronic apparatus. A computer system, such as a website, can be programmed to receive first information regarding the issuance of a tag, which includes encoded machine readable identification information, permitting a hunter to hunt, to store the first information in a database, to receive electronically from the person whom the tag was issued second information including an image of the dead animal, geographical information describing the position of the dead animal, and identifying information of the person to whom the tag was issued, to decode the machine-readable identification information, to store in the database the second information, to associate in first information with the second information using the decoded identification information, and to output upon request a confirmation.

A multitude of field use devices 220 can send information to, and/or receive information from, the computer 210 simultaneously or at different times. Each field use device 220 can separately communicate with the website and/or database 210 to upload information, for example, of kills of hunters in various locations. A multitude of issuing devices 200 can also send information to the computer 210 simultaneously or at different times.

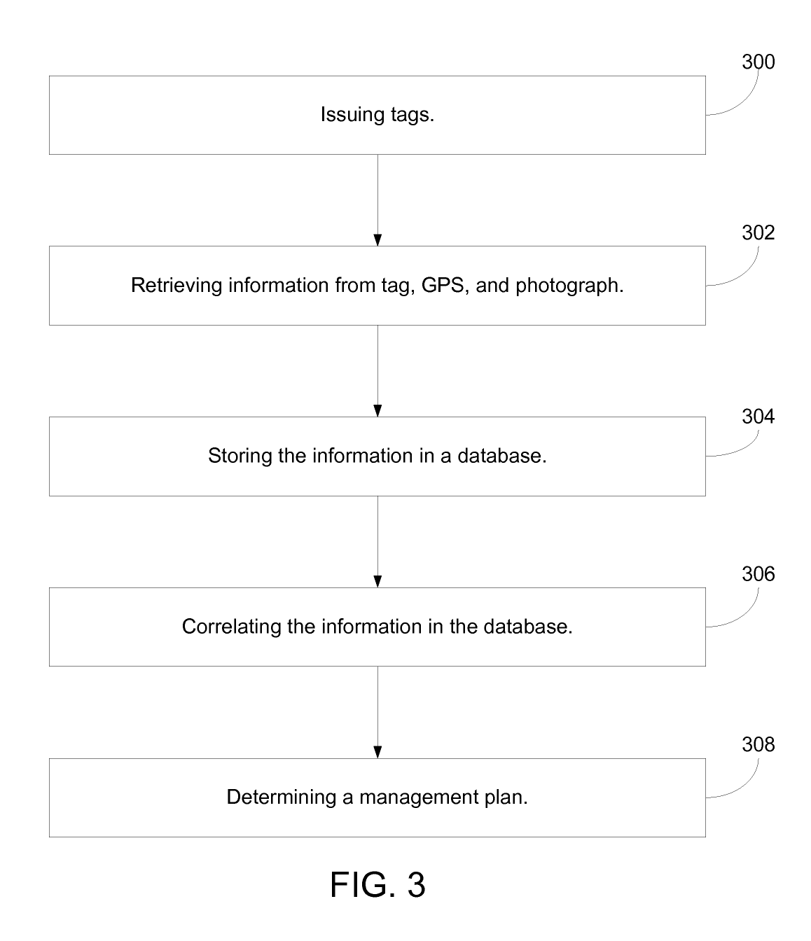

FIG. 3 shows a method of tracking killed animals according to an embodiment of the present invention. In step 300, a tag, which contains machine-readable coded information identifying the person to whom the tag is issued, is given to a person, e.g., a hunter or individual who may encounter a dead animal. Information concerning the issuance of the tag is uploaded to a database. In step 302, information is obtained from the tag, which is attached to a dead animal, and a photograph of the dead animal and GPS coordinates are acquired. The GPS coordinates are associated with the photograph. In step 304, the tag information, photograph, and GPS coordinates are stored in the database. In step 306, the related information in the database is correlated. In step 308, a management plan of the information in the database is determined. This plan governs the way the information is stored and displayed to users accessing the database for information.

While the embodiments above are described with respect to wildlife harvested by hunters, the invention is not limited to that application. Embodiments of the invention are useful, for example, is tracking wildlife killed by vehicles, wildlife dying of natural causes, including marine wildlife washing up onto beaches. By creating a database that includes the location of wildlife, information identifying the reporting individual, and preferably a photograph of the dead animal, wildlife can be managed and animal deaths can be tracked.

A preferred method or apparatus of the present invention has many novel aspects, and because the invention can be embodied in different methods or apparatuses for different purposes, not every aspect need be present in every embodiment. Moreover, many of the aspects of the described embodiments may be separately patentable. The invention has broad applicability and can provide many benefits as described and shown in the examples above. The embodiments will vary greatly depending upon the specific application, and not every embodiment will provide all of the benefits and meet all of the objectives that are achievable by the invention. The term “bar-coded tag” may also include microchips or other types of computer-readable labeling media.

It should be recognized that embodiments of the present invention can be implemented via computer hardware, a combination of both hardware and software, or by computer instructions stored in a non-transitory computer-readable memory. The methods can be implemented in computer programs using standard programming techniques—including a non-transitory computer-readable storage medium configured with a computer program, where the storage medium so configured causes a computer to operate in a specific and predefined manner—according to the methods and figures described in this Specification. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits programmed for that purpose.

Further, methodologies may be implemented in any type of computing platform, including but not limited to, personal computers, mini-computers, main-frames, workstations, networked or distributed computing environments. Aspects of the present invention may be implemented in machine readable code stored on a non-transitory storage medium or device, whether removable or integral to the computing platform, such as a hard disc, optical read and/or write storage mediums, RAM, ROM, and the like, so that it is readable by a programmable computer, for configuring and operating the computer when the storage media or device is read by the computer to perform the procedures described herein. Moreover, machine-readable code, or portions thereof, may be transmitted over a wired or wireless network. The invention described herein includes these and other various types of non-transitory computer-readable storage media when such media contain instructions or programs for implementing the steps described above in conjunction with a microprocessor or other data processor. The invention also includes the computer itself when programmed according to the methods and techniques described herein.

Computer programs can be applied to input data to perform the functions described herein and thereby transform the input data to generate output data. The output information is applied to one or more output devices such as a display monitor.

In the following discussion and in the claims, the terms “including” and “comprising” are used in an open-ended fashion, and thus should be interpreted to mean “including, but not limited to . . . .” To the extent that any term is not specially defined in this specification, the intent is that the term is to be given its plain and ordinary meaning. The accompanying drawings are intended to aid in understanding the present invention and, unless otherwise indicated, are not drawn to scale.

Although the present invention and its advantages have been described in detail, it should be understood that various changes, substitutions, and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method of tracking dead animals, comprising:
issuing to a person a tag including machine-readable coded information for identifying an animal;
providing a unique ID identifying the individual or class of individuals that the tag is issued to;
uploading information about the issuance of the tag to a database;
attaching the tag to a dead animal;
photographing the dead animal with the tag attached;
obtaining location information for where the animal was killed or found dead;
associating the photograph with the location information;
obtaining additional information regarding the animal such as sex and approximate age;
uploading the photograph, the location information, animal specific information and identifying information of the animal and identifying information of the class of person to a database, that database providing information regarding animals killed and their geographic locations.

2. A method for tracking animals killed, comprising:
issuing to a user a tag to be attached to an animal, the tag include a machine-readable unique identifier, the unique identifier and user information being stored in a computer database;
receiving uploaded information after the tag is attached to an animal, the uploaded information being obtained from a scan of tag with a device capable of reading the tag and the uploaded information including the unique identifier;
receiving additional uploaded information not recorded on the tag;
associating the uploaded information and the additional uploaded information with the user; and
storing the uploaded information in the computer database.

3. The method of claim 2 in which receiving additional uploaded information includes receiving information generated by the device.

4. The method of claim 3 in which information generated by the device includes location information and/or device identification information.

5. The method of claim 2 in which receiving additional uploaded information includes one or more photographs of the tagged animal.

6. The method of claim 2 in which receiving additional uploaded information includes receiving additional information manually entered into the device.

7. The method of claim 6 in which receiving additional information manually entered into the device includes receiving information about the sex and/or the age of the animal killed.

8. The method of claim 2 in which receiving additional uploaded information not recorded on the tag includes receiving electronically an image of the dead animal and/or geographical information.

9. The method of claim 2 in which receiving additional uploaded information not recorded on the tag includes the sex and/or approximate age of the animal.

10. The method of claim 2 further comprising compiling from the database summary information of animals killed in a geographic region.

11. The method of claim 2 further comprising accessing the database by someone other than the person to whom the tag was issued to confirm that the killing of the animal was uploaded to the data base.

12. The method of claim 2 the machine-readable unique identifier is encoded in a bar code or a QRS code.

13. The method of claim 2 in which receiving uploaded information includes receiving the information through a global computer network, through a telephone network, or through a satellite network.

14. The method of claim 2 in which receiving uploaded information after the tag is attached to an animal includes receiving uploaded information after the tag is attached to an animal killed on private land belonging to a land owner and further comprising providing access to the land owner to data base information regarding animals killed on the landowner's land.

15. The method of claim 2 in which receiving uploaded information after the tag is attached to an animal includes receiving uploaded information after the tag is attached to an animal killed by collision with a vehicle and in which information about the animal is uploaded by a law enforcement officer or another government official.

16. A method of tracking animals harvested by hunters, comprising:
receiving a tag including machine-readable coded information identifying the animal killed, the tag associated with a unique ID corresponding to the person to whom the tag is issued;
attaching the tag to the animal when it is killed or found dead;
scanning the tag with a device to retrieve information stored on the tag;
obtaining information not stored on the tag; and
uploading from the device the information retrieved from the tag and the information not stored on tag to a database remote from the scanning device.

17. The method of claim 16 in which obtaining information not stored on the tag includes obtaining an image of the dead animal and/or geographical information describing the position of the dead animal.

18. The method of claim 16 in which obtaining information not stored on the tag includes manually entering data into the device.

19. A computer system having a connection with a computer network for sending and receiving and receiving data and having computer readable memory for storing a computer instructions to:
receive first information regarding the issuance of a tag permitting a hunter to hunt, the tag including encoded machine readable identification information;
store the first information in a database;
receive electronically from the person to whom the tag was issued second information including an image of a dead animal killed by the hunter, geographical information describing the GPS location of the dead animal, additional information about the animal such as sex and approximate age, and identifying information of the person to whom the tag was issued;
decode the machine-readable identification information;
store in the database the second information;
associate the first information with the second information using the decoded identification information; and
output upon request information stored in the database.

20. The computer system of claim 19 in which the computer instruction to receive electronically from the person to whom the tag was issued second information includes computer instructions to receive additional information about the animal.

21. The computer system of claim 19 in which the computer instruction to receive additional information about the animal includes computer instructions to receive information about the sex and/or age of the animal.
